(19) United States
(12) Patent Application Publication
(10) Pub. No.: US 2024/0025571 A1
(43) Pub. Date: Jan. 25, 2024

(54) SHOOTING METHOD, DEVICE, COMPUTER-READABLE STORAGE MEDIUM, AND TERMINAL DEVICE

(71) Applicant: SZ DJI TECHNOLOGY CO., LTD., Shenzhen (CN)

(72) Inventors: Zhihua YANG, Shenzhen (CN); Minglei ZHANG, Shenzhen (CN); Jiabin LIANG, Shenzhen (CN)

(73) Assignee: SZ DJI TECHNOLOGY CO., LTD., Shenzhen (CN)

(21) Appl. No.: 18/374,553

(22) Filed: Sep. 28, 2023

Related U.S. Application Data
(63) Continuation of application No. PCT/CN2021/084724, filed on Mar. 31, 2021.

(51) Int. Cl. B64U 20/87; G05D 1/10

(52) U.S. Cl. CPC B64U 20/87; G05D 1/101; B64U 2101/18

(57) ABSTRACT

A shooting method is provided, including: obtaining position information of a shooting object; planning a first circumnavigation route and a second circumnavigation route for surrounding shooting of the shooting object based on the position information; controlling a UAV to move along the first circumnavigation route and the second circumnavigation route respectively; and controlling the UAV to shoot the shooting object by a camera mounted on the UAV during movement to obtain multiple images of the shooting object. Images collected on the first circumnavigation route and images collected on the second circumnavigation route share homologous image points of the shooting object. The images are used to establish a three-dimensional model of the shooting object. Thus, the shooting efficiency of the UAVs is improved for shooting images for three-dimensional reconstruction.

### RELATED APPLICATIONS

This application is a continuation application of PCT application No. PCT/CN2021/084724, filed on Mar. 31, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of image shooting, and in particular to a shooting method and device, a computer-readable storage medium, and a terminal device.

### BACKGROUND

Three-dimensional reconstruction technology based on unmanned aerial vehicle (UAV) images is increasingly used in the refined modeling of cultural relics, power towers, signal towers, bridges and other objects. When using a UAV for modeling, the UAV may be controlled to fly along a planned route to capture images of an object during its flight. The captured images may be used to create a three-dimensional model of the object. Currently, UAVs take a lot of time to shoot images, and the operating efficiency still needs to be improved.

### SUMMARY

In light of the foregoing, the present disclosure provides a shooting method and device, a computer-readable storage medium, a terminal device, and a model obtaining method. One objective of the present disclosure is to improve the efficiency of images captured by a UAV.

In one aspect, the present disclosure provides a model obtaining method, including: controlling a movable object carrying a load to move along a first path, and control the load, while moving, to collect first information of a target object during a movement; establishing, based on the first information, an initial model of the target object; planning, based on the initial model, at least one second path and a preset condition; controlling the movable object to move along the at least one second path, and controlling the load, while moving, to collect second information of the target object; and determining, based on at least the second information, a target model of the target object.

In another aspect, the present disclosure provides a model obtaining method, including: obtaining position information of a target object; planning, based on the position information, a first path and a second path for collecting information of the target object; controlling a movable object to move along the first path and the second path respectively, where the first path is different from the second path; controlling a load on the movable object to collect information of the target object while the movable object is moving, where first information collected by the load on the first path and second information collected by the load on the second path share information of at least one point of the target object; and establishing, based on the first information and the second information, a target model of the target object.

The shooting method provided by some exemplary embodiments of the present disclosure plans a first circumnavigation route and a second circumnavigation route. Since images collected by a camera of the UAV on a first circumnavigation route and images collected by the camera of the UAV on the second circumnavigation route include homologous image points of a shooting object. Therefore, the images collected by the UAV on the second circumnavigation route may be matched and connected with the images collected by the UAV on the first circumnavigation route, and accordingly, the degree of overlap between images collected by the UAV during the second circumnavigation route may be reduced, thereby reducing the number of images to be captured. Moreover, the shooting distance corresponding to the second circumnavigation route may be shorter than the shooting distance corresponding to the first circumnavigation route. Therefore, the images collected by the UAV on the second circumnavigation route may retain more details on the surface of the shorting object, making a three-dimensional model established have sufficient accuracy. It may be seen that the shooting method provided by the present disclosure may reduce the number of images to be shot on the basis of ensuring that the accuracy of the three-dimensional model meets the requirements, and improves the operating efficiency of the UAV.

### BRIEF DESCRIPTION OF THE DRAWINGS

In order to more clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a flow chart of a shooting method according to some exemplary embodiments of the present disclosure.

FIG. 2 is a schematic diagram of a route according to some exemplary embodiments of the present disclosure.

FIG. 3 is a top view of a first circumnavigation route of an imitation surface according to some exemplary embodiments of the present disclosure.

FIG. 4 is a side view of a second circumnavigation route of imitation surface according to some exemplary embodiments of the present disclosure.

FIG. 5 is a schematic diagram of a route when planning multiple first circumnavigation routes according to some exemplary embodiments of the present disclosure.

FIG. 6 is a schematic diagram of a route when two second circumnavigation routes are planned according to some exemplary embodiments of the present disclosure.

FIG. 7 is a side view of three routes planned according to some exemplary embodiments of the present disclosure.

FIG. 8 is a schematic diagram of feature point matching with an initial model according to some exemplary embodiments of the present disclosure.

FIG. 9 is a flow chart of a model obtaining method according to some exemplary embodiments of the present disclosure.

FIG. 10 is a flow chart of a shooting method according to some exemplary embodiments of the present disclosure.

FIG. 11 is a schematic diagram of an interactive interface according to some exemplary embodiments of the present disclosure.

FIG. 12 is a schematic diagram of an interactive interface according to some exemplary embodiments of the present disclosure.

FIG. 13 is a schematic structural diagram of a shooting device according to some exemplary embodiments of the present disclosure.

FIG. 14 is a schematic structural diagram of a model obtaining device according to some exemplary embodiments of the present disclosure.

FIG. 15 is a schematic structural diagram of a terminal device according to some exemplary embodiments of the present disclosure.

### DETAILED DESCRIPTION

The technical solutions in some exemplary embodiments of the present disclosure will be described below in conjunction with the drawings. Apparently, the described embodiments are some exemplary embodiments of the present disclosure, but not all of them. Based on the examples disclosed herein, all other embodiments obtained by a person of ordinary skill in the art without creative efforts should fall within the scope of protection of the present disclosure.

Three-dimensional reconstruction technology based on UAV images is increasingly used in the refined modeling of cultural relics, power towers, signal towers, bridges and other objects. When using a UAV for modeling, the UAV may be controlled to fly along a planned route and capture images of a shooting object during the flight, and a three-dimensional model of the shooting object may be built with the captured images. Currently, UAVs take a lot of time to capture images, and the operating efficiency still needs to be improved.

In order to make an established shooting object model have high accuracy, according to some exemplary embodiments, a route (or path or moving path) may be planed close to the surface of the shooting object. When the UAV (or any movable object, where UAV is merely an example herein) moves along the route and shoots images of the shooting object, due to the close distance between the UAV and the shooting object, the captured images may retain more details on the surface of the shooting object, thereby ensuring that the model established has high accuracy. However, because the UAV is close to the shooting object, the captured images may cover smaller areas. In order to fully cover the entire shooting object and meet the overlap requirements between images, the UAV needs to shoot a large number of images, which consumes a lot of time and results in low operating efficiency.

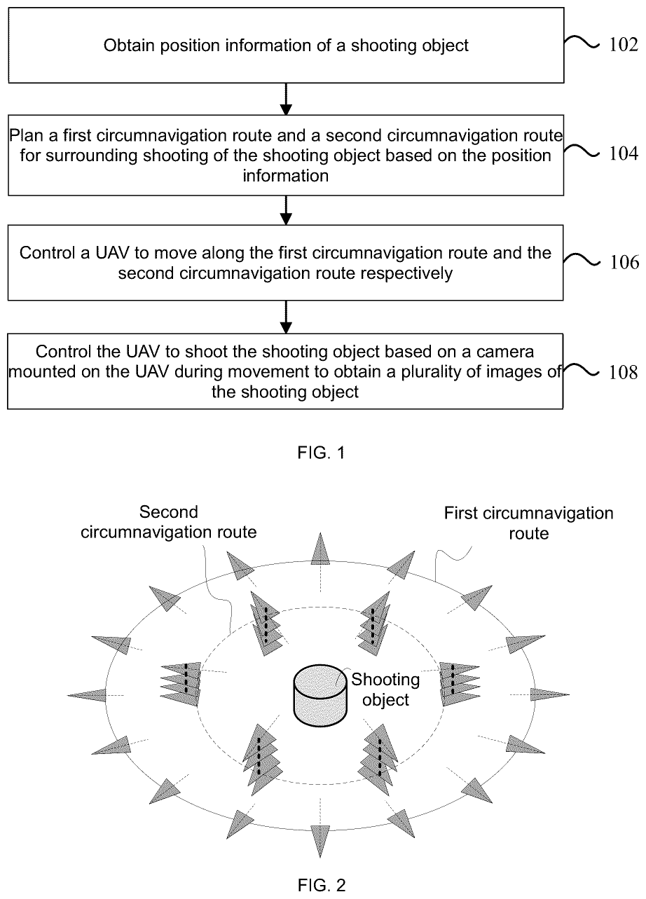

Some exemplary embodiments of the present disclosure provide a shooting method. With reference to FIG. 1; FIG. 1 is a flow chart of a shooting method provided by some exemplary embodiments of the present disclosure. The method includes the following steps:

S102. Obtain position information of a shooting object.

S104. Plan a first circumnavigation route and a second circumnavigation route for surrounding shooting of the shooting object based on the position information.

S106. Control a UAV to move along the first circumnavigation route and the second circumnavigation route respectively.

S108. Control the UAV to shoot the shooting object based on a camera (it would be any load carried by the UAV/movable device, where camera is merely an example of the load) mounted on the UAV during movement to obtain a plurality of images of the shooting object.

The position information of the shooting object may indicate the location of the shooting object. In one example, the position information of the shooting object may be the geometric coordinates of the location of the shooting object. In some exemplary embodiments, the position information of the shooting object may be input or selected by a user. In some exemplary embodiments, the position information of the shooting object may be obtained by the UAV via sensors. For example, the UAV may be equipped with a radar device, and the position information of the shooting object may be obtained by way of radar detection. In another example, the UAV may obtain the position information of the shooting object via visual positioning.

The first circumnavigation route and the second circumnavigation route may be planned based on the position information of the shooting object. Herein, the first circumnavigation route and the second circumnavigation route may be used for surrounding shooting of the shooting object. In an example, the first circumnavigation route and the second circumnavigation route may have the location of the shooting object as a surrounding center.

The UAV may be controlled to move along the first circumnavigation route and the second circumnavigation route respectively. The UAV may maintain a first distance from the shooting object while moving along the first circumnavigation route. The UAV may maintain a second distance from the shooting object while moving along the second circumnavigation route. Herein, the first distance may be greater than the second distance. In some exemplary embodiments, the first circumnavigation route may include multiple waypoints. The distance from the waypoints on the first circumnavigation route to the shooting object may be the first distance. In some exemplary embodiments, the shooting distance corresponding to the first circumnavigation route may be the first distance. Similarly, In some exemplary embodiments, the second circumnavigation route may include multiple waypoints. The distance from the waypoints on the second circumnavigation route to the shooting object may be the second distance. In some exemplary embodiments, the shooting distance corresponding to the second circumnavigation route may be the second distance.

It should be noted that the UAV may maintain a first distance from the shooting object while moving along the first circumnavigation route refers to that when the UAV moves along the first circumnavigation route, the distance between it and the shooting object is roughly maintained close to the first distance. That is, it may be slightly longer than the first distance, or slightly shorter than the first distance. In the same way, that the UAV may maintain a second distance from the shooting object while moving along the second circumnavigation route refers to that when the UAV moves along the second circumnavigation route, the distance between it and the shooting object is roughly maintained close to the second distance. That is, it may be slightly longer than the second distance, or slightly shorter than the second distance.

The UAV may be equipped with a camera. When controlling the UAV to move along the first circumnavigation route and the second circumnavigation route respectively, the UAV may be controlled to use the camera to capture images of the shooting object during its movement, so that multiple images of the shooting object may be obtained. When the UAV moves along the first circumnavigation route or the second circumnavigation route, in some exemplary embodiments, the UAV may be controlled to capture one or more images for every preset time interval. In some exemplary embodiments, the UAV may be controlled to capture one or more images every time it passes through a preset angle or a preset distance. Specifically, when setting the shooting interval, it may be set according to the shooting range of the camera and the required image overlap.

In some exemplary embodiments, an image(s) collected by the camera on the first circumnavigation route of the UAV may include a first image area; an image(s) collected by the camera on the second circumnavigation route of the UAV may include a second image area. The first image area and the second image area correspond to the same position of the shooting object. For example, the shooting object may be a high-voltage transmission tower structure; the first image area may include an imaging area at the connection between the tower body and the power line, and the second image area includes the same imaging area.

In some exemplary embodiments, the controlling of the UAV to shoot/capture images of the shooting object based on the camera mounted on the UAV during movement to obtain multiple images of the shooting object, where the images captured by the camera on the first circumnavigation route of the UAV and the images captured by the camera on the second circumnavigation route of the UAV include homologous image points, includes:

The UAV is at a first position of the first circumnavigation route, and the camera collects a first image; the UAV is at a second position on the second circumnavigation route, and the camera collects a second image; the first image and the second image include homologous image points, the first position and the second position have a preset relative positional relationship. For example, the first position and the second position are located in the same direction of the shooting object.

Among the multiple images captured, the images collected by the UAV on the first circumnavigation route and the images collected by the UAV on the second circumnavigation route may include imaging of the same area of the shooting object. That is to say, the images collected by the camera on the first circumnavigation route by the UAV and the images collected by the camera on the second circumnavigation route by the UAV may include homologous image points of the object. Therefore, when using the images for three-dimensional reconstruction, the images collected by the UAV on the first circumnavigation route may match the images collected by the UAV on the second circumnavigation route.

The multiple images captured may be used to build a three-dimensional model of the shooting object. In this case, there may be many algorithms to build the model. For example, a multi-view geometric algorithm may be used to build a three-dimensional point cloud model of the shooting object. The three-dimensional model of the shooting object may also be various types of models, for example, it may be a point cloud model or a mesh model.

The shooting method provided by some exemplary embodiments of the present disclosure may plan the first circumnavigation route and the second circumnavigation route. The images captured by the camera when the UAV is on the first circumnavigation route and the images captured by the camera when the UAV is on the second circumnavigation route include homologous image points of the object. Therefore, the images collected by the UAV on the second circumnavigation route may be matched and linked to the images collected by the UAV on the first circumnavigation route. Thus, the overlap degree between images collected by the UAV on the second circumnavigation route may be reduced, thereby reducing the number of images to be captured. Moreover, the shooting distance corresponding to the second circumnavigation route may be smaller than the shooting distance corresponding to the first circumnavigation route. As a result, the images captured by the UAV on the second circumnavigation route may retain more details of the shooting object surface, so that the established three-dimensional model may have sufficient accuracy. It may be seen that the shooting method provided herein reduce the number of images to be captured while ensuring that the accuracy of the three-dimensional model meets requirements, thereby improving the operating efficiency of the UAV.

In some exemplary embodiments, the first circumnavigation route may include multiple waypoints, and the multiple waypoints may be distributed in different directions with respect to the shooting object. The multiple waypoints may be approximately in the same distance from the shooting object, and the multiple waypoints may be approximately at the same altitude (the approximately herein includes cases of being the same or being substantially the same). Reference may be made to FIG. 2, which is a schematic diagram of a route provided according to some exemplary embodiments of the present disclosure. In an example, the first circumnavigation route may also be referred to as a horizontal circumnavigation route. When controlling the UAV to move along the first circumnavigation route, the UAV may move around the shooting object on a horizontal plane at a certain altitude.

In some exemplary embodiments, the second circumnavigation route may include multiple vertical route segments, and the multiple vertical route segments may be distributed in different directions with respect to the shooting object. Each vertical route segment may include multiple waypoints distributed at different altitudes. The projection positions of these waypoints on the horizontal plane may be roughly the same, see FIG. 2. In one example, the second circumnavigation route may also be refers to as the vertical circumnavigation route. When controlling the UAV to move along the second circumnavigation route, the UAV may move along each vertical route segment separately. Specifically, when the UAV moves along the vertical route segments, it may move upward or downward in the vertical direction.

In one example, the images collected by the UAV on the first circumnavigation route may cover the surface of the shooting object in different directions. In one example, the images collected by the UAV in a certain vertical route segment may cover the surface of the shooting object at various heights in a certain direction.

It is understandable that on the first circumnavigation route the UAV may capture images of the shooting object in different directions. On the vertical route segments, the UAV may capture multiple images of the shooting object at different altitudes in a specific direction. Since the range covered by the images captured by the UAV on the first circumnavigation route includes the range covered by the images captured by the UAV on the vertical route segment, the images captured by the UAV on the vertical route segments may match the images captured by the UAV on the first circumnavigation route, meeting the overlap degree requirements. Therefore, the image overlap degree requirement between vertical route segments may be greatly reduced (may be less than 20%). There is no need to plan dense vertical route segments, which may reduce the time spent on UAV shooting and improves operational efficiency. Moreover, because the distribution of vertical route segments may be relatively sparse, it may adapt to more complex scenarios, and the scene adaptability is greatly improved. In addition, since two circumnavigation routes are used for shooting, the coverage of the shooting object is more comprehensive and shooting blind spots may be avoided.

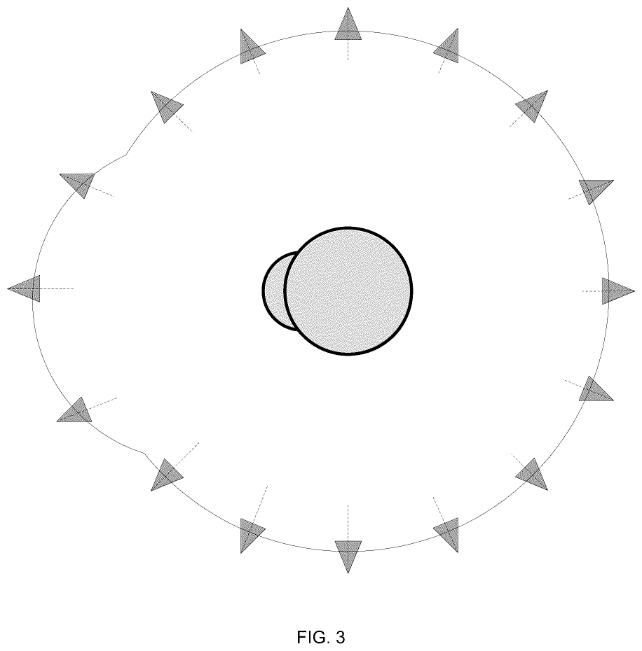

In some exemplary embodiments, the shape of the planned first circumnavigation route may match the contour shape of the shooting object on the horizontal plane. In this way, the distances from each waypoint on the first circumnavigation route to the surface point of the shooting object may be the same, which is the first distance. The first circumnavigation route whose shape matches the contour shape of the shooting object on the horizontal plane may be referred to the first circumnavigation route of an imitation surface. With reference to FIG. 3; it is a top view of a first circumnavigation route of an imitation surface according to some exemplary embodiments of the present disclosure.

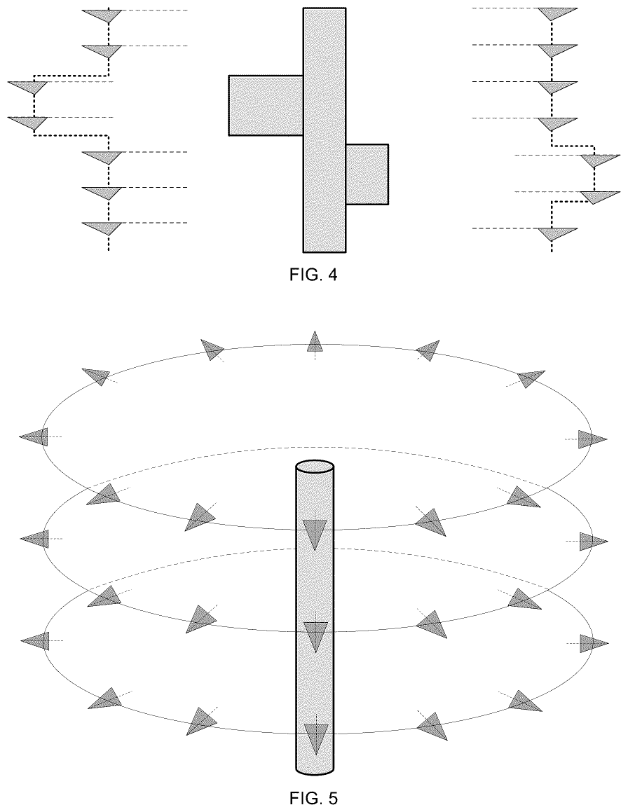

In some exemplary embodiments, the shape of the vertical flight segment in the planned second circumnavigation route may be matched to the contour shape of the shooting object in the vertical plane. In this way, the distance from each waypoint on the vertical flight segment to the corresponding surface point of the shooting object may be the same, all of which are the aforementioned second distance. This second circumnavigation route with the shape of the vertical flight segment matched to the contour shape of the shooting object in the vertical plane may be referred to as the second circumnavigation route of imitation surface. For reference, see FIG. 4, which is a side view of a second circumnavigation route of imitation surface according to some exemplary embodiments of the present disclosure.

In some exemplary embodiments, the first circumnavigation route of imitation surface may be planned based on an initial model of the shooting object and the set first distance, and the second circumnavigation route of imitation surface may be planned based on the initial model of the shooting object and the set second distance. Herein, the initial model of the shooting object may include the position information of the surface points of the shooting object, so the distance between the waypoint and the surface point of the shooting object may be determined.

The initial model of the shooting object may be obtained by three-dimensional reconstruction using multiple primary images of the shooting object. In some exemplary embodiments, if a first circumnavigation route of imitation surface and a second circumnavigation route of imitation surface need to be planned, the initial model of the shooting object needs to be obtained in advance. The initial images of the shooting object may be obtained in a variety of ways. In one example, multiple primary images of the shooting object may be obtained by pre-shooting the shooting object by a camera. In another example, multiple primary images may be obtained by surrounding shooting the shooting object at a long distance by a UAV. Here, since the primary images are obtained by UAV long-distance shooting, the accuracy of the established initial model is relatively low, which may be referred to as a coarse model.

In some exemplary embodiments, if only the second circumnavigation route of the imitation surface is planned, and the first circumnavigation route does not need the imitation surface, the initial model of the shooting object may be obtained by three-dimensional reconstruction using the images collected by the UAV on the first circumnavigation route. It is understandable that in order to establish the initial model of the shooting object, the images collected by the UAV need to fully cover the shooting object. Therefore, when planning the first circumnavigation route, multiple first circumnavigation routes corresponding to different altitudes may be planned based on the position information of the shooting object. Reference may be made to FIG. 5. FIG. 5 is a schematic diagram of a route when planning multiple first circumnavigation routes according to some exemplary embodiments of the present disclosure. After planning multiple first circumnavigation routes, the UAV may be controlled to move along each first circumnavigation route and shoot images of the shooting object, so that multiple primary images that fully cover the shooting object may be obtained. The multiple primary images may be used to establish an initial model of the shooting object, and the initial model may then be used to plan the second circumnavigation route of the imitation surface.

In some exemplary embodiments, multiple first circumnavigation routes with large shooting distances may be planned. In this way, the images collected by the UAV on the first circumnavigation route may cover a large range of scenes. Even if there is a large gap(s) between the multiple planned first circumnavigation routes, the image overlap degree between the routes may still meet the requirements. There are large intervals (that is, relatively sparse) between the multiple first circumnavigation routes, which may improve the adaptability to complex scenes and reduce the openness requirements of the scene.

In order for the images collected by the UAV on the first circumnavigation route to match the images collected by the UAV on the second circumnavigation route, the difference between the first distance corresponding to the first circumnavigation route and the second distance corresponding to the second circumnavigation route should be within a reasonable range. In some exemplary embodiments, the first distance and the second distance may satisfy a specific proportional relationship. For example, the second distance may be ½ of the first distance, then the first distance may be denoted as D and the second distance may be denoted as 0.5 D.

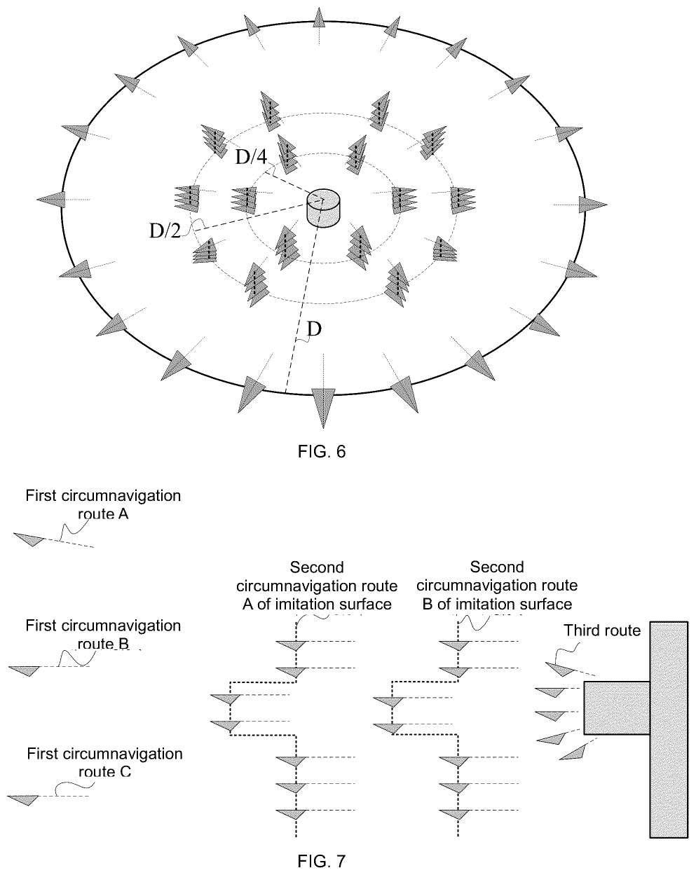

The difference between the first distance and the second distance needs to be limited within a reasonable range. In this regard, if the shooting distance of the first circumnavigation route is relatively far away, although the shooting distance of the second circumnavigation route is closer than that of the first circumnavigation route, it may still be relatively far away with the limitation of the distance gap. For example, the first distance of the first circumnavigation route is 20 meters, and then the second distance of the second circumnavigation route may be 10 meters, which is still far away from the shooting object. In this case, the images collected by the UAV on the second circumnavigation route may have insufficient details, causing the accuracy of the final model to fail to meet the requirements. To solve this problem, In some exemplary embodiments, multiple second circumnavigation routes corresponding to different shooting distances may be planned. In one example, the shooting distance between the first circumnavigation route and each second circumnavigation route may satisfy a geometric relationship. For example, two second circumnavigation routes are planned; the shooting distance of the first circumnavigation route may be recorded as D, and the shooting distances of the two second circumnavigation routes may be D/2 and D/4 respectively. Reference may be made to FIG. 6, which is a schematic diagram of a route when two second circumnavigation routes are planned according to some exemplary embodiments of the present disclosure.

When planning the first circumnavigation route, in some exemplary embodiments, the shooting distance (that is, the first distance) of the first circumnavigation route may be determined based on the dimensional information of the shooting object. The dimensional information of the shooting object may match the three-dimensional shape that the shooting object is abstracted into. For example, if the shooting object is abstracted into a cuboid, the dimensional information of the shooting object may include the length, width and height of the shooting object. If the shooting object is abstracted into a cylinder, the dimensional information of the shooting object may include the height and base diameter of the shooting object. Please refer to FIG. 2. The shooting object in FIG. 2 is abstracted as a cylinder. The shooting object's dimensional information, in one example, may be user-entered. In one example, it may also be measured by the UAV through visual measurement or other methods.

In some exemplary embodiments, after determining the dimensional information of the shooting object, the dimensional information of the shooting object may be converted into the shooting distance(s) corresponding to the first circumnavigation route with a preset calculation formula. For example, the shooting object is abstracted as a cylinder with a base diameter of 1 meter, and the preset calculation formula may be, for example, taking N times the base diameter. Thus, the shooting distance of the first circumnavigation route may be N meters.

In some exemplary embodiments, herein the shooting distance of the route, the distance between the UAV and the shooting object and the distance between the waypoint and the shooting object may all be horizontal distances. For example, the distance between the waypoint and the shooting object may be the distance from the projection position of the waypoint on the horizontal plane to the projection position of the shooting object on the same horizontal plane.

Considering that users may have higher modeling requirements for certain areas of the shooting object, for example, in the modeling task of a signal tower, a user may require higher accuracy for the model of the antenna on the signal tower. Therefore, in some exemplary embodiments, a third route may be planned for close-up shots of the region of interest. Specifically, the region of interest on the surface of the shooting object selected by the user is obtained, and a third route may be planned based on the region of interest. Thus, the UAV may be controlled to move along the third route and take multiple close-range images of the shooting object during the movement. To facilitate distinction, the images taken by the UAV along the first circumnavigation route may be referred to as the first images, the images taken along the second circumnavigation route may be referred to as the second image, and the images taken along the third route may be referred to as the third images. When performing three-dimensional reconstruction, the farthest first images, the medium-distance second images, and the closest third images may be used to establish a high-precision model of the shooting object.

With reference to FIG. 7; FIG. 7 is a side view of three routes planned according to some exemplary embodiments of the present disclosure. The planned routes include three first circumnavigation routes A, B and C for long-distance shooting of shooting objects, two imitation surface second circumnavigation routes A and B for mid-range shooting of shooting objects, and a third route for close-range shooting of shooting object.

In some exemplary embodiments, if multiple second circumnavigation routes are planned, the shooting distances of the first circumnavigation route, the multiple second circumnavigation routes and the third route may satisfy an equal ratio relationship. For example, if two second circumnavigation routes are planned, the shooting distance of the first circumnavigation route may be recorded as D, the shooting distances of the two second circumnavigation routes may be D/2 and D/4 respectively, and the shooting distance of the third route may be D/8. Through such a shooting distance setting, it may be ensured that the images collected by the UAV on the third route may match and link to the images collected by the UAV on the second circumnavigation route. As a result, a high-precision three-dimensional model of the shooting object may be successfully established.

In some exemplary embodiments, when planning a third route based on a selected region of interest, multiple waypoints may be planned at a preset distance from the surface of the shooting object's region of interest, and a third route may be planned based on the multiple planned waypoints. In one example, the multiple planned waypoints may be relatively evenly distributed based on the region of interest of the shooting object, and spaced apart from the surface of the shooting object by the preset distance. In one example, the third route may include multiple route segments, and the lateral overlap degree between the route segments may be greater than 60%, and the heading overlap degree within a route segment may be greater than 80%.

In some exemplary embodiments, the region of interest on the surface of the shooting object may be selected by a user in the image of the shooting object that has been taken. In this case, the captured image of the shooting object may include the first image and the second image, and may also include a currently captured preview image. In some exemplary embodiments, the region of interest may be selected by the user on the initial model of the shooting object.

In some exemplary embodiments, when using multiple captured images to build a three-dimensional model of the shooting object, feature points of the multiple images may be matched. The three-dimensional reconstruction may be performed based on a result of feature point matching, and thus a three-dimensional model of the shooting object may be obtained. Herein, the multiple images used for the three-dimensional reconstruction may include images collected by the UAV on (each) the first circumnavigation route and images collected on (each) the second circumnavigation route. In other examples, images collected by the UAV on a third route may also be included.

The first image may be used to refer to any image among multiple images. When performing feature point matching on multiple images, in some exemplary embodiments, feature points of the first image and images other than the first image may be matched respectively. Although this method may determine the image(s) that matches the first image, it requires a large amount of calculation and has low reconstruction efficiency. In some exemplary embodiments, the initial model of the shooting object may be used to match feature points between multiple images. Specifically, the initial model may be used to determine candidate images from multiple images, and feature points of the first image and those of the candidate images may then be matched.

In some exemplary embodiments, when using the initial model to determine candidate images, the camera attitude information corresponding to the first image may be obtained to screen out multiple pending images whose camera attitude information matches the camera attitude information of the first image from multiple images; the initial model may be used to identify pending images from multiple pending images. The camera attitude information may be the information carried in the image(s), which may indicate the position and attitude of the camera when the image(s) was taken. It is understandable that the closer the camera is when shooting, the higher the similarity between the captured images and the more matching feature points. Therefore, multiple images may be screened based on the camera attitude information, and multiple pending images may be screened out.

The initial model of the shooting object may be utilized when determining candidate images from multiple pending images. In some exemplary embodiments, the feature points of the first image may be projected onto the initial model, and the following operations may be performed on each pending image: based on the camera attitude information of the pending image, feature points are back-projected from the initial model to the plane where the pending image is located, and the number of feature points within the pending image is counted. After counting the number of feature points contained in each pending image, the candidate image may be determined based on the number of feature points corresponding to each pending image. Herein, in an example, N pending images containing the largest number of feature points may be determined as candidate images, and N may be a natural number greater than 0.

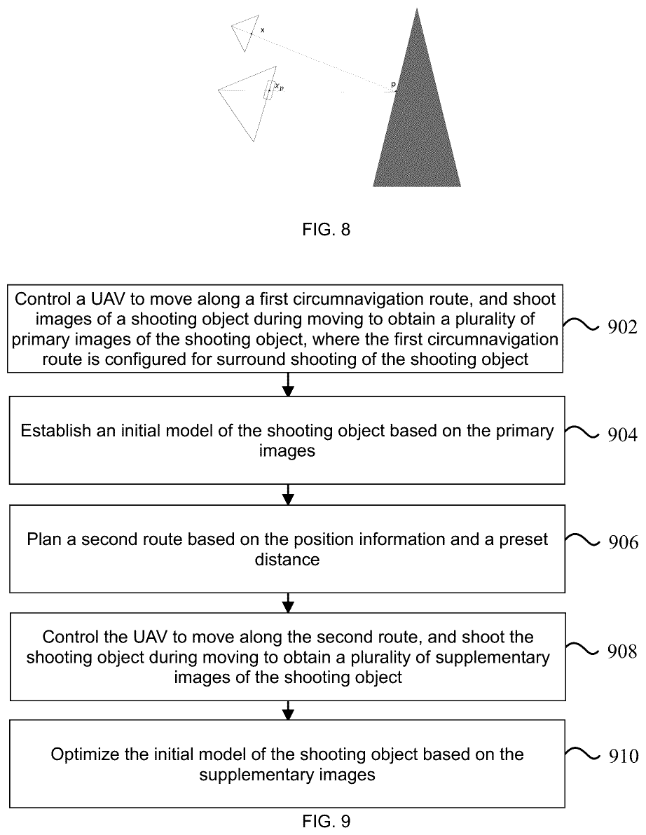

After the candidate image is determined, feature points of the first image and the candidate image may be matched. In some exemplary embodiments, the feature points in the first image may be matched with the feature points in a target range in the candidate image. The target range may be a range where the feature point falls after the feature points in the first image is back-projected from the initial model to the plane where the candidate image is located. Reference may be made to FIG. 8, which is a schematic diagram of feature point matching with an initial model according to some exemplary embodiments of the present disclosure. After a feature point x in the first image is projected onto the initial model, a three-dimensional point p may be obtained; the landing point after the three-dimensional point p is back-projected to the plane where the candidate image is located may be xp. When matching feature points between the first image and the candidate image, the feature point x may be matched with the feature points within the range of the landing point xp in the candidate image. It improves matching efficiency and matching success rate, making the three-dimensional reconstruction process more robust. Herein, the range where the landing point is located may be a range at a specific distance from the landing point location.

According to the shooting method provided by some exemplary embodiments of the present disclosure, a first circumnavigation route and a second circumnavigation route are planned, the images captured by the camera of the UAV on the first circumnavigation route and the images captured by the camera of the UAV on the second circumnavigation route include homologous image points. Therefore, the images collected by the UAV on the second circumnavigation route may be matched and linked with the images collected by the UAV on the first circumnavigation route. Furthermore, the overlap degree between the images collected by the UAV on the second circumnavigation route may be reduced, thereby reducing the number of images to be captured. Moreover, the shooting distance corresponding to the second circumnavigation route is smaller than the shooting distance corresponding to the first circumnavigation route. Therefore, the images collected by the UAV on the second circumnavigation route may retain more details of the shooting object surface, so that the established three-dimensional model has sufficient accuracy. It may be seen that the shooting method provided by herein may reduce the number of images to be shot on the basis of ensuring that the accuracy of the three-dimensional model meets the requirements, thereby improving the operating efficiency of the UAV.

Next, with reference to FIG. 9, which is a flow chart of a model obtaining method according to some exemplary embodiments of the present disclosure, the method includes the following steps:

S902. Control a UAV to move along a first circumnavigation route, and shoot images of a shooting object during moving to obtain a plurality of primary images of the shooting object, where the first circumnavigation route is configured for surround shooting of the shooting object.

S904. Establish an initial model of the shooting object based on the primary images, where the initial model includes position information of surface points of the shooting object.

S906. Plan a second route based on the position information and a preset distance, where the second route includes a plurality of waypoints, and the distances between the plurality of waypoints and a surface of the shooting object are approximately equal.

S908. Control the UAV to move along the second route, and shoot the shooting object during moving to obtain a plurality of supplementary images of the shooting object.

S910. Optimize the initial model of the shooting object based on the supplementary images.

In the above steps, S902 and S904 may be referred to the relevant descriptions in the previous sections, and will not be repeated herein.

After establishing the initial model of the shooting object, where the initial model includes the position information of the surface points of the shooting object, the second route may be planned based on the position information of the surface points of the shooting object and the preset distance. On the planned second route, the distances from each waypoint to the surface of the shooting object may be approximately equal, and are all equal to the preset distance (the approximately herein includes cases of being the same or being substantially the same).

It may be understood that, the preset distance may be the distance from the waypoint on the second route to the shooting object, and it may be the shooting distance of the second route.

The UAV may be controlled to move along the second route and shoot the shooting object, and multiple supplementary images corresponding to the shooting object may be obtained. Herein, in some exemplary embodiments, the preset distance may be less than the distance between the waypoint on the first circumnavigation route and the shooting object. Therefore, when the UAV flies along the second route, the shooting object may be shot at a closer distance, and supplementary images taken may improve the accuracy of the initial model.

In some exemplary embodiments, when optimizing the initial model of the shooting object based on the supplementary images, three-dimensional reconstruction may be performed using multiple supplementary images and multiple first images collected by the UAV on the first circumnavigation route. The reconstruction may result in an optimized model with higher accuracy than the initial model.

According to the model obtaining method provided by some exemplary embodiments of the present disclosure, the initial model of the shooting object may be established using multiple primary images taken when the UAV moves along the first circumnavigation route; and the second route may be planned based on the position information and preset distance of the shooting object surface points included in the initial model. The accuracy of the second route may be improved so that the distances from the waypoints on the second route to the surface of the shooting object are approximately equal. Moreover, multiple compensation images taken by the UAV moving along the second route may be used to optimize the initial model of the shooting object, thereby improving the quality of the initial model.

In some exemplary embodiments, multiple second routes may be planned based on the position information of the shooting object and multiple preset distances. In this case, the second route may correspond to the second circumnavigation route mentioned above, which may include multiple vertical route segments, and the multiple vertical route segments may be distributed in different directions with respect to the shooting object, where each vertical route segment may be used to guide the UAV to move upward or downward in the vertical direction.

In some exemplary embodiments, the corresponding preset distances (shooting distances) of the multiple planned second routes may satisfy the equal ratio relationship. For example, three second routes may be planned, and the shooting distance of the first circumnavigation route may be recorded as D, then the shooting distances of the three second routes may be D/2, D/4, and D/8 respectively.

In some exemplary embodiments, the planned second route may be used to shoot close-up shots of the region of interest. In this case, the planned second route may correspond to the third route mentioned above. Specifically, the region of interest selected by a user may be obtained. In this way, the second route may be planned based on the position information of the surface points of the shooting object, the region of interest and the preset distance.

In some exemplary embodiments, the optimizing of the initial model of the shooting object based on the supplementary images may include:
Performing feature point matching on the multiple supplementary images, and optimizing the initial model of the shooting object based on a feature point matching result.

In some exemplary embodiments, the performing of the feature point matching on the multiple supplementary images may include:

Performing feature point matching among the multiple supplementary images based on the initial model.

In some exemplary embodiments, the performing of the feature point matching among the multiple supplementary images based on the initial model may include:
Using the initial model to determine a candidate supplementary image for feature point matching with a first supplementary image from the multiple supplementary images, the first supplementary image being any supplementary image among the multiple supplementary images;
Performing feature point matching between the first supplementary image and the candidate supplementary image.

In some exemplary embodiments, the using of the initial model to determine the candidate supplementary image for feature point matching with the first supplementary image from the multiple supplementary images may include:
Screening multiple pending supplementary images whose camera attitude information matches the camera attitude information corresponding to the first supplementary image among the multiple supplementary images;
Using the initial model to determine the candidate supplementary image from the multiple pending supplementary images.

In some exemplary embodiments, the using of the initial model to determine the candidate supplementary image from the multiple pending supplementary images may include:
Projecting feature points of the first supplementary image to the initial model;
For each pending supplementary image, back-projecting the feature points thereof from the initial model to a plane where the pending supplementary image is located based on the camera attitude information corresponding to the pending supplementary image, and determining the number of feature points located within the pending supplementary image;
Determining the candidate supplementary image based on the number of the feature points corresponding to each of the pending supplementary images.

Various exemplary embodiments of the model obtaining method are provided above. For specific descriptions, please refer to the relevant contents in the previous section, which will not be repeated herein.

According to the model obtaining method provided by some exemplary embodiments of the present disclosure, the initial model of the shooting object may be established using multiple primary images taken when the UAV moves along the first circumnavigation route, and then the second route may be planned based on the position information and preset distance of the shooting object surface points included in the initial model. The accuracy of the second route may be improved so that the distances from the waypoints on the second route to the surface of the shooting object may be approximately equal. Moreover, multiple compensation images taken by the UAV moving along the second route may be used to optimize the initial model of the shooting object, thereby improving the quality of the initial model.

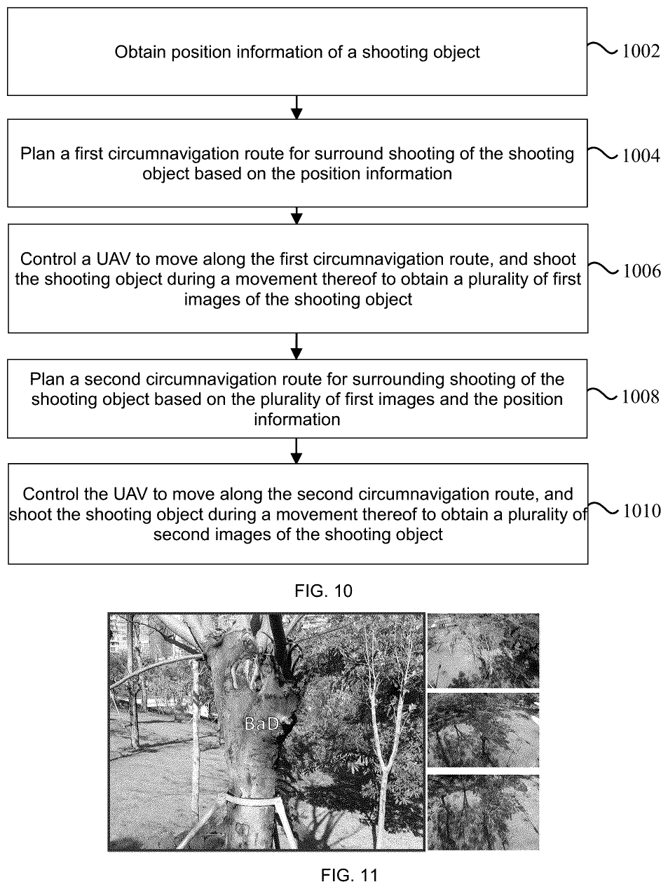

With reference to FIG. 10, FIG. 10 is a flow chart of a shooting method according to some exemplary embodiments of the present disclosure. The method may include the following steps:

S1002. Obtain position information of a shooting object.

S1004. Plan a first circumnavigation route for surround shooting of the shooting object based on the position information.

S1006. Control a UAV to move along the first circumnavigation route, and shoot the shooting object during a movement thereof to obtain a plurality of first images of the shooting object.

S1008. Plan a second circumnavigation route for surrounding shooting of the shooting object based on the plurality of first images and the position information.

S1010. Control the UAV to move along the second circumnavigation route, and shoot the shooting object during a movement thereof to obtain a plurality of second images of the shooting object.

The first images and the second images may be used to establish a three-dimensional model of the shooting object.

Regarding S1002, S1004 and S1006, reference may be made to the relevant descriptions in the previous section, which will not be repeated herein.

After obtaining multiple first images of the shooting object taken when the UAV moves along the first circumnavigation route, the second circumnavigation route may be planned based on the position information of the shooting object and the multiple first images. In one example, the position information of the shooting object may be used to determine a surrounding center of the second circumnavigation route. In one example, the multiple first images may be used to determine a distance between waypoints on the second circumnavigation route and the shooting object.

In some exemplary embodiments, the shooting distance corresponding to the planned second circumnavigation route may be smaller than the shooting distance corresponding to the first circumnavigation route. That is, the distance between the waypoints on the second circumnavigation route and the shooting object may be smaller than the distance between the waypoints on the first circumnavigation route and the shooting object.

When determining the distance between the waypoints on the second circumnavigation route and the shooting object based on the multiple first images, in some exemplary embodiments, the UAV may be controlled to maintain a test distance from the shooting object, where the test distance may be any distance smaller than the distance between the waypoints on the first circumnavigation route and the shooting object. The UAV may be controlled to shoot the shooting object at the specified test distance to obtain a test image. This test image may be matched for similarity with the multiple first images taken when the UAV moves along the first circumnavigation route. If the similarity obtained by the matching does not meet a condition, the test distance may be adjusted. If the similarity obtained by matching meets the condition, the adjusted test distance may be determined as the distance between the waypoints on the second circumnavigation route and the shooting object. In some exemplary embodiments, the similarity obtained by the matching may be the highest similarity obtained after the similarity matching between the test image and multiple first images.

As mentioned before, the shooting distance of the second circumnavigation route may be smaller than the shooting distance of the first circumnavigation route. The test distance is used as a trial value of the shooting distance of the second circumnavigation route, which may be smaller than the shooting distance of the first circumnavigation route. That is, it may be less than the distance between the waypoints on the first circumnavigation route and the shooting object.

It should be noted that the images captured by the UAV on the second circumnavigation route and the images captured by the UAV on the first circumnavigation route need to meet a certain degree of similarity, so that these images can be well matched when used for three-dimensional reconstruction, avoiding the problem that the images cannot be connected in the end. However, the similarity between the images captured by the UAV on the second circumnavigation route and the images captured by the UAV on the first circumnavigation route should not be too high. Because the higher the similarity, the closer the shooting distance of the second circumnavigation route is to the shooting distance of the first circumnavigation route, then the images taken by the UAV on the second circumnavigation route may have a limited improvement in model accuracy, which may ultimately lead to insufficient accuracy of the established model; or in order to make the accuracy of the established model meet the requirements, it is necessary to plan more routes corresponding to different shooting distances, which may greatly increase the workload of UAV shooting and greatly reduce the shooting efficiency.

To address the above problems, some exemplary embodiments, after the similarity matching between the test image and multiple first images, if the similarity obtained by the matching is less than a lower limit of similarity, the test distance may be increased to make the shooting distance of the second circumnavigation route closer to the shooting distance of the first circumnavigation route, so as to ensure that the images captured by the UAV on the second circumnavigation route may be connected with the images captured by the UAV on the first circumnavigation route. In some exemplary embodiments, if the similarity obtained by the matching is greater than an upper limit of similarity, it means that the shooting distance of the second circumnavigation route is too close to the shooting distance of the first circumnavigation route, then the test distance may be reduced so that images taken by the UAV on the second circumnavigation route may contribute more to the improvement of model accuracy.

Considering that the UAV may take a large number of images when moving along the first circumnavigation route, if the test image is used for similarity matching with each of the first images, it may consume more computing resources and reduce the computing efficiency. Therefore, in some exemplary embodiments, the camera attitude information corresponding to the test image may be obtained, and then the multiple first images may be screened based on the camera attitude information corresponding to the test image. The test image may be then matched in similarity with the first image obtained from the screening. Herein, the camera attitude information may be the information carried by the test image. In one example, the camera attitude information may be measured by an inertial measurement unit on the UAV or camera. Since the matching of the camera attitude information of two images means that the shooting angles of the two images are roughly the same, the similarity between the images is high, the test image may be similar to the screened first image, thereby improving the matching efficiency. In some exemplary embodiments, the multiple first images may also be screened by an image retrieval algorithm. Therefore, a small number first images or a single first image may also be screened out for similarity matching with the test image.

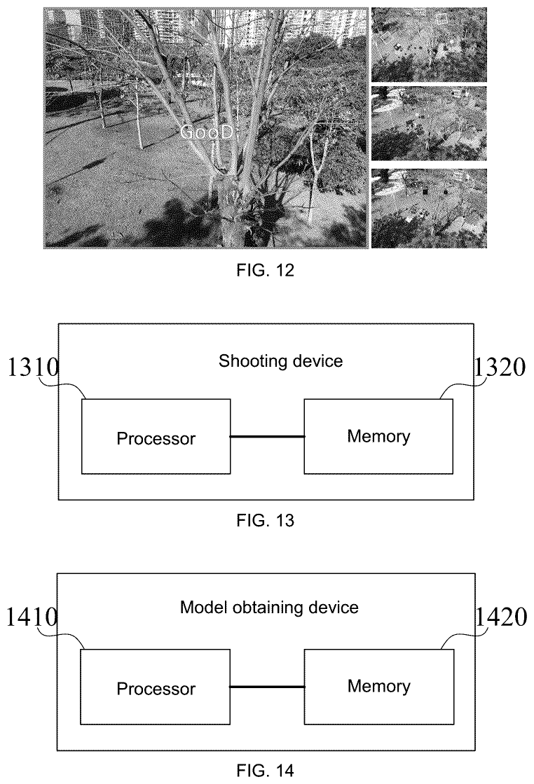

In some exemplary embodiments, when a user controls the UAV to shoot the shooting object at a test distance, if the matching result between the captured test image and the first images does not meet the condition, for example, the similarity is greater than the upper limit of similarity or less than the lower limit of similarity, the corresponding matching result may be fed back to the user to guide the user to adjust the test distance. With reference to FIG. 11 and FIG. 12, in one example, if the matching result does not meet the condition, information indicating that the current test distance is inappropriate may be displayed on a display interface of the terminal, such as the BAD shown in FIG. 11. If the matching result meets the condition, information indicating that the current test distance is appropriate may be displayed on the display interface of the terminal, such as the GOOD shown in FIG. 12.

There are many ways to perform the similarity matching between the test image and the first images. In some exemplary embodiments, feature extraction may be performed on the test image and the first images respectively, and the extracted feature may be a high-dimensional feature vector, then the similarity between the test image and the first images may be calculated using the feature vector corresponding to the test image and the feature vectors corresponding to the first images. For example, the similarity may be an angle between the feature vectors of the test image and the first image. It may also be the distance between the feature vectors of the test image and the first image.

According to the shooting method provided by some exemplary embodiments of the present disclosure, the second circumnavigation route may be planned based on the multiple first images taken when the UAV moves along the first circumnavigation route. This ensures that the images captured by the UAV on the second circumnavigation route may match the images captured by the UAV on the first circumnavigation route, avoiding the problem of image inability to connect during three-dimensional reconstruction.

Reference may be made below to FIG. 13, which is a schematic structural diagram of a shooting device according to some exemplary embodiments of the present disclosure. The shooting device provided by some exemplary embodiments of the present disclosure may include: a processor 1310 and a memory 1320 storing a computer program. In some exemplary embodiments, the processor may implement the following steps when executing the computer program:
Obtain position information of a shooting object;
Plan a first circumnavigation route and a second circumnavigation route for surrounding shooting of the shooting object based on the position information;
Control a UAV to move along the first circumnavigation route and the second circumnavigation route respectively, where the UAV maintains a first distance from the shooting object while moving along the first circumnavigation route, the UAV maintains a second distance from the shooting object while moving along the second circumnavigation route, and the first distance is greater than the second distance;
Control the UAV to shoot the shooting object based on a camera mounted on the UAV during movement to obtain multiple images of the shooting object, where the images captured by the camera on the UAV on the first circumnavigation route and the images captured by the camera on the UAV on the second circumnavigation route include homologous image points, and multiple images are used to establish a three-dimensional model of the shooting object.

In some exemplary embodiments, the first circumnavigation route includes multiple waypoints, and the multiple waypoints are distributed in different directions with respect to the shooting object, they have approximately the same distance from the shooting object and are approximately at the same altitude. The first circumnavigation route is used to guide the UAV to surround the shooting object on a horizontal plane.

In some exemplary embodiments, the distance from each waypoint on the first circumnavigation route to the surface point of the shooting object is the first distance, and the shape of the first circumnavigation route matches the contour shape of the shooting object on the horizontal plane.

In some exemplary embodiments, the second circumnavigation route includes multiple vertical route segments, and the multiple vertical route segments may be distributed in different directions with respect to the shooting object, where each vertical route segment is used to guide the UAV to move upward or downward in a vertical direction.

In some exemplary embodiments, the distance from each waypoint on the vertical route segment to a surface point(s) of the shooting object is the second distance, and the shape of the vertical route segment matches the contour shape of the shooting object on the vertical plane.

In some exemplary embodiments, position information of the surface point(s) of the shooting object may be determined based on an initial model of the shooting object, and the initial model may be established in advance based on multiple primary images of the shooting object.

In some exemplary embodiments, the processor is also used to:
Plan a third route according to a selected region of interest on the surface of the shooting object;
Control the UAV to move along the third route, and shooting the shooting object during the movement thereof.

In some exemplary embodiments, the distance between waypoints on the third route and the shooting object is smaller than the second distance.

In some exemplary embodiments, when using the multiple images to establish the three-dimensional model of the shooting object, the processor is used to:

Perform feature point matching on the multiple images, and perform three-dimensional reconstruction based on a feature point matching result to obtain a three-dimensional model of the shooting object.

In some exemplary embodiments, when performing the feature point matching on the multiple images, the processor is used to:

Use the initial model of the shooting object to match feature points between the multiple images, where the initial model is established in advance based on multiple primary images of the shooting object.

In some exemplary embodiments, when using the initial model of the shooting object to match feature points between the multiple images, the processor is used to:
Use the initial model of the shooting object to determine a candidate image for feature point matching with a first image of the multiple images, where the first image is any image among the multiple images;
Match feature points between the first image and the candidate image.

In some exemplary embodiments, when using the initial model of the shooting object to determine the candidate image for feature point matching with the first image from the multiple images, the processor is used to:
Screen multiple pending images whose camera attitude information matches camera attitude information corresponding to the first image of the multiple images;
Determine the candidate image among the multiple pending images using the initial model.

In some exemplary embodiments, when using the initial model to determine the candidate image from the multiple pending images, the processor is used to:
Project feature points of the first image to the initial model;
For each pending image, back-project feature points thereof from the initial model to a plane where the pending image is located based on the camera attitude information corresponding to the pending image, and determine the number of feature points located in the pending image;
Determine the candidate image based on the number of the feature points corresponding to each of the pending images.

For the various implementations of the shooting device provided above, reference may be made to the relevant descriptions in the foregoing for specific implementation, and details will not be described again herein.

According to the shooting device provided by some exemplary embodiment of the present application, the first circumnavigation route and the second circumnavigation route are planned, since the images captured by the camera on the UAV on the first circumnavigation route and the images captured by the camera on the UAV on the second circumnavigation route include homologous image points, the images collected by the UAV on the second circumnavigation route may be matched and connected with the images collected by the UAV on the first circumnavigation route. Furthermore, the overlap degree between the images collected by the UAV on the second circumnavigation route may be reduced, thereby reducing the number of images to be captured. Moreover, the shooting distance corresponding to the second circumnavigation route may be smaller than the shooting distance corresponding to the first circumnavigation route. Therefore, the images collected by the UAV on the second circumnavigation route may retain more details of the shooting object surface, so that the established three-dimensional model may have sufficient accuracy. It can be seen that the shooting device provided herein may reduce the number of images to be shot on the basis of ensuring that the accuracy of the three-dimensional model meets the requirements, thereby improving the operating efficiency of the UAV.

Reference may be made below to FIG. 14, which is a schematic structural diagram of a model obtaining device according to some exemplary embodiments of the present disclosure. The shooting device provided by some exemplary embodiments of the present disclosure may include: a processor 1410 and a memory 1420 storing a computer program. The processor executes the computer program to implement the following steps:
Control the UAV to move along the first circumnavigation route, and shoot the shooting object during the movement to obtain multiple primary images of the shooting object, where the first circumnavigation route is used for surround shooting the shooting object;
Establish an initial model of the shooting object based on the primary images, where the initial model includes position information of surface points of the shooting object;
Plan a second route based on the position information and a preset distance, where the second route includes multiple waypoints, and the distances between the waypoints and a surface of the shooting object are approximately equal;
Control the UAV to move along the second route, and shoot the shooting object during the movement to obtain multiple supplementary images of the shooting object;
Optimize the initial model of the shooting object based on the supplementary images.

In some exemplary embodiments, the preset distance is smaller than the distance between the waypoints on the first circumnavigation route and the shooting object.

In some exemplary embodiments, when planning the second route based on the position information and the preset distance, the processor is used to:

Plan multiple second routes based on the position information and multiple preset distances.

In some exemplary embodiments, the multiple preset distances satisfy an equal proportion relationship.

In some exemplary embodiments, when planning the second route based on the position information and the preset distance, the processor is used to:

Plan the second route based on the position information, a region of interest selected from the initial model and a preset distance, where waypoints on the second route are distributed within the region of interest.

In some exemplary embodiments, the first circumnavigation route includes multiple waypoints, the multiple waypoints are distributed in different directions with respect to the shooting object, have approximately the same distance from the shooting object, and are approximately located at the same altitude, where first circumnavigation route is used to guide the UAV to move around the shooting object on the horizontal plane.

In some exemplary embodiments, the second route includes multiple vertical route segments, and the multiple vertical route segments are distributed in different directions with respect to the shooting object, where each vertical route segment is used to guide the UAV to move upward or downward in a vertical direction.

In some exemplary embodiments, when optimizing the initial model of the shooting object based on the supplementary images, the processor is configured to:

Perform feature point matching on the multiple supplementary images, and optimize the initial model of the shooting object based on a feature point matching result.

In some exemplary embodiments, when performing the feature point matching on the multiple supplementary images, the processor is used to:

Use the initial model to perform feature point matching among/between the multiple supplementary images.

In some exemplary embodiments, when using the initial model to perform the feature point matching among/between the multiple supplementary images, the processor is used to:
Use the initial model to determine a candidate supplementary image for feature point matching with a first supplementary image from the multiple supplementary images, where the first supplementary image is any supplementary image among the multiple supplementary images;
Perform feature point matching between the first supplementary image and the candidate supplementary image.

In some exemplary embodiments, when using the initial model to determine the candidate supplementary image for feature point matching with the first supplementary image from the multiple supplementary images, the processor is used to:
Screen multiple pending supplementary images whose camera attitude information matches the camera attitude information corresponding to the first supplementary image from the multiple supplementary images;
Use the initial model is used to determine the candidate supplementary image from the plurality of pending supplementary images.

In some exemplary embodiments, when using the initial model to determine the candidate supplementary image from the multiple pending supplementary images, the processor is used to:
Project feature points of the first supplementary image to the initial model;
For each of the pending supplementary images, back-project the feature points from the initial model to a plane where the pending supplementary image is located according to the camera attitude information corresponding to the pending supplementary image, and determine the number of feature points located in the pending supplementary image;
Determine the candidate supplementary image based on the number of the feature points corresponding to each of the pending supplementary images.

For the various implementations of the model obtaining device provided above, reference may be made to the relevant descriptions in the foregoing for their specific implementation, which will not be described again herein.

According to the model obtaining device provided in some exemplary embodiments of the present disclosure, the initial model of the shooting object may be established using multiple primary images taken when the UAV moves along the first circumnavigation route, and the second route may be planned based on the position information and preset distance of the shooting object surface points included in the initial model. In order to improve the accuracy of the second route, the distances from the waypoints on the second route to the surface of the shooting object are approximately equal. Moreover, multiple compensation images taken by the UAV moving along the second route may be used to optimize the initial model of the shooting object, thereby improving the quality of the initial model.

Some exemplary embodiments of the present application also provide a shooting device, the structure of which can be referred to FIG. 13. The processor of the device implements the following steps when executing the computer program stored in the memory:

Obtain position information of a shooting object;

Plan a first circumnavigation route for surrounding shooting of the shooting object based on the position information;

Control a UAV to move along the first circumnavigation route, and shoot the shooting object during the movement to obtain multiple first images of the shooting object;

Plan a second circumnavigation route for surrounding shooting of the shooting object based on the multiple first images and the position information;

Control the UAV to move along the second circumnavigation route, and shoot the shooting object during the movement to obtain multiple second images of the shooting object, where the first images and the second images are used to establish a three-dimensional model of the shooting object.

In some exemplary embodiments, the distance between the waypoints on the second circumnavigation route and the shooting object is determined based on the multiple first images.

In some exemplary embodiments, when determining the distance between the waypoints on the second circumnavigation route and the shooting object based on the multiple first images, the processor is used to:
Control the UAV to maintain a test distance from the shooting object and shoot the shooting object to obtain a test image, where test distance is less than the distance between the waypoints on the first circumnavigation route and the shooting object;
Perform similarity matching between the test image and the multiple first images, and adjust the test distance according to a similarity obtained by the matching;
Determine an adjusted test distance as the distance between the waypoints on the second circumnavigation route and the shooting object.

In some exemplary embodiments, when adjusting the test distance according to the similarity obtained by the matching, the processor is used to:

If the similarity obtained by the matching is less than a lower limit of similarity, increase the test distance.

In some exemplary embodiments, when adjusting the test distance according to the similarity obtained by the matching, the processor is used to:

If the similarity obtained by the matching is greater than a lower limit of similarity, decrease the test distance.

In some exemplary embodiments, when performing the similarity matching between the test image and multiple first images, the processor is configured to:
Screen out a first image whose camera attitude information matches the camera attitude information corresponding to the test image from the multiple first images;
Perform similarity matching between the test image and the first image obtained from the screening.

For the various implementations of the shooting device provided above, reference may be made to the relevant descriptions in the foregoing for their specific implementation, and details will not be described again herein.

The shooting device provided by some exemplary embodiments of the present disclosure may plan the second circumnavigation route based on multiple first images taken when the UAV moves along the first circumnavigation route. This ensures that the images captured by the UAV on the second circumnavigation route may match the images captured by the UAV on the first circumnavigation route, avoiding the problem of image inability to connect during three-dimensional reconstruction.

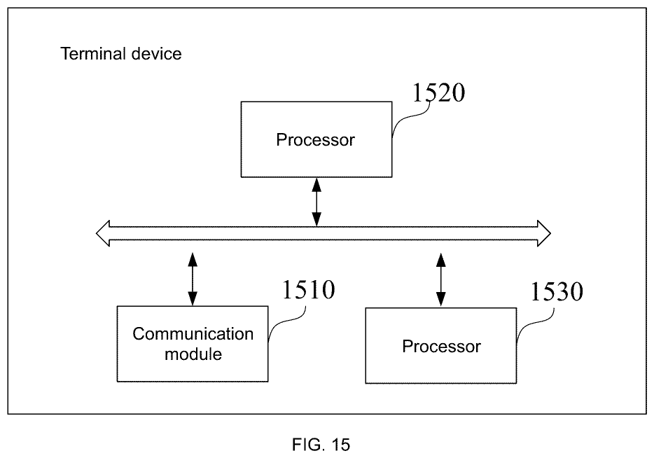

Reference may be made below to FIG. 15, which is a schematic structural diagram of a terminal device according to some exemplary embodiments of the present disclosure. The terminal device may include:

A communication module 1510, used to establish a connection with the UAV; and

A processor 1520 and a memory 1530 storing computer programs.

In some exemplary embodiments, the processor executes the computer program to implement the following steps:
Obtain position information of a shooting object;
Plan a first circumnavigation route and a second circumnavigation route for surrounding shooting of the shooting object based on the position information;
Control a UAV to move along the first circumnavigation route and the second circumnavigation route respectively, where the UAV maintains a first distance from the shooting object while moving along the first circumnavigation route, the UAV maintains a second distance from the shooting object while moving along the second circumnavigation route, and the first distance is greater than the second distance;
Control the UAV to shoot the shooting object by a camera mounted on the UAV while moving to obtain multiple images of the shooting object, where images captured by the camera on the UAV along the first circumnavigation route and images captured by the camera on the UAV along the second circumnavigation route of the UAV share homologous image points, and the multiple images are used to establish a three-dimensional model of the shooting object.

In some exemplary embodiments, the first circumnavigation route includes multiple waypoints, the multiple waypoints are distributed in different directions with respect to the shooting object, are approximately in the same distance from the shooting object, and are approximately located at the same altitude, the first circumnavigation route is configured to guide the UAV to move around the shooting object on a horizontal plane.

In some exemplary embodiments, the distance from each waypoint on the first circumnavigation route to surface points of the shooting object is the first distance, and the shape of the first circumnavigation route matches the contour shape of the shooting object on the horizontal plane.

In some exemplary embodiments, the second circumnavigation route includes multiple vertical route segments, and the multiple vertical route segments are distributed in different directions with respect to the shooting object, and each vertical route segment is configured to guide the UAV to move upward or downward in the vertical direction.

In some exemplary embodiments, the distance from each waypoint on the vertical route segment to the surface points of the shooting object is a second distance, and the shape of the vertical route segment matches the contour shape of the shooting object on the vertical plane.

In some exemplary embodiments, the position information of the surface points of the shooting object is determined based on the initial model of the shooting object, and the initial model is established in advance based on multiple primary images of the shooting object.

In some exemplary embodiments, the processor is also used to:
Plan a third route according to a selected region of interest on a surface of the shooting object;
Control the UAV to move along the third route and shoot the shooting object during the movement.

In some exemplary embodiments, the distance between the waypoints on the third route and the shooting object is smaller than the second distance.

In some exemplary embodiments, when using the multiple images to establish the three-dimensional model of the shooting object, the processor is used to:

Perform feature point matching on the multiple images, and perform three-dimensional reconstruction based on a feature point matching result to obtain a three-dimensional model of the shooting object.

In some exemplary embodiments, when performing the feature point matching on the multiple images, the processor is used to:

Use the initial model of the shooting object to match feature points among/between the multiple images, where the initial model is established in advance based on multiple primary images of the shooting object.

In some exemplary embodiments, when using the initial model of the shooting object to match feature points among/between the multiple images, the processor is used to:
Use the initial model of the shooting object to determine a candidate image for feature point matching with a first image from the multiple images, where the first image is any image among the plurality of images;
Match feature points between the first image and the candidate image.

In some exemplary embodiments, when using the initial model of the shooting object to determine the candidate image for feature point matching with the first image from the multiple images, the processor is used to:
Select multiple pending images whose camera attitude information matches the camera attitude information corresponding to the first image by screening the multiple images;
Determine the candidate image from the multiple pending images based on the initial model.

In some exemplary embodiments, when using the initial model to determine the candidate image from the multiple pending images, the processor is used to:
Project feature points of the first image to the initial model;
For each pending image, back-project the feature points from the initial model to a plane where the pending image is located according to the camera attitude information corresponding to the pending image, and determine the number of feature points located in the pending image;
Determine the candidate image based on the number of the feature points corresponding to each of the pending images.

For the various implementations of the terminal device provided above, reference may be made to the relevant descriptions in the foregoing for specific implementation, and details will not be described again herein.

The terminal device provided by some exemplary embodiment of the present disclosure, the first circumnavigation route and the second circumnavigation route are planned, since the images captured by the camera on the UAV on the first circumnavigation route and the images captured by the camera on the UAV on the second circumnavigation route include/share homologous image points, the images collected by the UAV on the second circumnavigation route may be matched and connected with the images collected by the UAV on the first circumnavigation route. Furthermore, the overlap degree between the images collected by the UAV on the second circumnavigation route may be reduced, thereby reducing the number of images to be captured. Moreover, the shooting distance corresponding to the second circumnavigation route is smaller than the shooting distance corresponding to the first circumnavigation route. Therefore, the images collected by the UAV on the second circumnavigation route may retain more details of the shooting object surface, so that the established three-dimensional model has sufficient accuracy. It can be seen that the terminal device provided herein may reduce the number of images to be taken while ensuring that the accuracy of the three-dimensional model meets the requirements, thereby improving the operating efficiency of the UAV.

Some exemplary embodiments of the present application also provide a terminal device, the structure of which may be referred to FIG. 15. The processor in the terminal device executes the computer program to implement the following steps:
Control the UAV to move along the first circumnavigation route, and shoot the shooting object during the movement to obtain multiple primary images of the shooting object, where the first circumnavigation route is configured to perform surrounding shooting on the shooting object;
Establish an initial model of the shooting object based on the primary images, where the initial model includes position information of surface points of the shooting object;
Plan a second route based on the position information and a preset distance, where the second route includes multiple waypoints, and the distances between the waypoints and a surface of the shooting object are approximately equal;
Control the UAV to move along the second route, and shoot the shooting object during the movement to obtain multiple supplementary images of the shooting object;
Optimize the initial model of the shooting object based on the supplementary images.

In some exemplary embodiments, the preset distance is smaller than the distance between the waypoints on the first circumnavigation route and the shooting object.

In some exemplary embodiments, when planning the second route based on the position information and the preset distance, the processor is used to:

Plan multiple second routes based on the position information and multiple preset distances.

In some exemplary embodiments, the multiple preset distances satisfy an equal proportion relationship.

In some exemplary embodiments, when planning the second route based on the position information and the preset distance, the processor is used to:

Plan the second route based on the position information, a region of interest selected from the initial model and the preset distance, where waypoints on the second route are distributed within the region of interest.

In some exemplary embodiments, the first circumnavigation route includes multiple waypoints, the multiple waypoints are distributed in different directions of the shooting object, are in approximately the same distance from the shooting object, and are approximately located at the same altitude, and the first circumnavigation route is configured to guide the UAV to move around the shooting object on the horizontal plane.

In some exemplary embodiments, the second route includes multiple vertical route segments, the multiple vertical route segments are distributed in different directions with respect to the shooting object, and each vertical route segment is configured to guide the UAV to move upward or downward in a vertical direction.

In some exemplary embodiments, when optimizing the initial model of the shooting object based on the supplementary images, the processor is used to:
Perform feature point matching on the multiple supplementary images, and optimize the initial model of the shooting object based on a feature point matching result.

In some exemplary embodiments, when performing feature point matching on the multiple supplementary images, the processor is used to:

Use the initial model to perform the feature point matching among/between the multiple supplementary images.

In some exemplary embodiments, when using the initial model to perform feature point matching among/between the multiple supplementary images, the processor is used to:
Use the initial model to determine a candidate supplementary image for feature point matching with a first supplementary image from the multiple supplementary images, where the first supplementary image is any supplementary image among the multiple supplementary images;
Match feature points between the first supplementary image and the candidate supplementary image.

In some exemplary embodiments, when using the initial model to determine the candidate supplementary image for feature point matching with the first supplementary image from the multiple supplementary images, the processor is use to:
Select multiple pending supplementary images whose camera attitude information matches the camera attitude information corresponding to the first supplementary image from the multiple supplementary images;
Use the initial model to determine the candidate supplementary image from the multiple pending supplementary images.

In some exemplary embodiments, when using the initial model to determine the candidate supplementary image from the multiple pending supplementary images, the processor is used to:
Project feature points of the first supplementary image to the initial model;
For each of the pending supplementary images, back-project the feature points from the initial model to a plane where the pending supplementary image is located according to the camera attitude information corresponding to the pending supplementary image, and determine the number of feature points located in the pending supplementary image;
Determine the candidate supplementary image based on the number of the feature points corresponding to each of the pending supplementary images.

For the various implementations of the terminal device provided above, reference may be made to the relevant descriptions in the foregoing for specific implementation, and details will not be described again herein.

According to the terminal device provided by some exemplary embodiments of the present disclosure, the initial model of the shooting object may be established using multiple primary images taken when the UAV moves along the first circumnavigation route, and the second route may be planned based on the position information and preset distance of the shooting object surface points included in the initial model, so as to improve the accuracy of the second route, the distance from the waypoints on the second route to the shooting object surface may be approximately equal. Moreover, multiple compensation images taken by the UAV moving along the second route may be used to optimize the initial model of the shooting object, thereby improving the quality of the initial model.

Some exemplary embodiments of the present disclosure also provides a terminal device, the structure of which may be referred to FIG. 15. The processor in the terminal device executes the computer program to implement the following steps:
Obtain position information of a shooting object;
Plan a first circumnavigation route for surrounding shooting of the shooting object based on the position information;
Control a UAV to move along the first circumnavigation route, and shoot the shooting object during the movement to obtain multiple first images of the shooting object;
Plan a second circumnavigation route for surrounding shooting of the shooting object based on first images and the position information;
Control the UAV to move along the second circumnavigation route, and shoot the shooting object during the movement to obtain multiple second images of the shooting object, where the first images and the second images are configured to establish a three-dimensional model of the shooting object.

In some exemplary embodiments, the distance between the waypoints on the second circumnavigation route and the shooting object is determined based on the first images.

In some exemplary embodiments, when determining the distance between the waypoints on the second circumnavigation route and the shooting object based on the first images, the processor is used to:
Control the UAV to maintain a test distance from the shooting object and shoot the shooting object to obtain a test image, where a test distance is less than the distance between the waypoints on the first circumnavigation route and the shooting object;
Perform similarity matching between the test image and multiple first images, and adjust the test distance according to a similarity obtained by the matching;
Determine an adjusted test distance as the distance between the waypoints on the second circumnavigation route and the shooting object.

In some exemplary embodiments, when adjusting the test distance according to the similarity obtained by the matching, the processor is used to:

If the similarity obtained by the matching is less than a lower limit of similarity, increase the test distance.

In some exemplary embodiments, when adjusting the test distance according to the similarity obtained by the matching, the processor is used to:

If the similarity obtained by the matching is greater than a lower limit of similarity, decrease the test distance.

In some exemplary embodiments, when performing the similarity matching between the test image and the multiple first images, the processor is configured to:
Select a first image whose camera attitude information matches the camera attitude information corresponding to the test image from the first images;
Perform similarity matching between the test image and the selected first image.

For the various implementations of the terminal device provided above, reference may be made to the relevant descriptions in the foregoing for specific implementation, and details will not be described again herein.

According to the terminal device provided by some exemplary embodiments of the present disclosure, the second circumnavigation route may be planned based on multiple first images taken when the UAV moves along the first circumnavigation route. This ensures that the images captured by the UAV on the second circumnavigation route may match the images captured by the UAV on the first circumnavigation route, avoiding the problem of image inability to connect during three-dimensional reconstruction.

Some exemplary embodiments of the present disclosure also provide a computer-readable storage medium; the computer-readable storage medium stores a computer program; when the computer program is executed by the processor, any shooting method and any model acquisition method provided herein may be implemented.

The above provides exemplary embodiments for each protection subject matter. On the basis that there is no conflict or contradiction, a person skilled in the art may freely combine them according to the actual situations, thereby forming various different technical solutions. However, due to space limitations, it is not possible to describe all the combined technical solutions; yet it can be understood that these technical solutions also belong to the scope disclosed in the present disclosure.

Some exemplary embodiments of the present disclosure may take the form of a computer program product implemented on one or more storage media (including but not limited to disk storage, CD-ROM, optical storage, etc.) containing program code. The storage media available for computers include permanent (non-transitory) and non-permanent (transitory), removable and non-removable media, and may be implemented by any method or technology to store information. Information may be computer-readable instructions, data structures, modules of programs, or other data. Examples of the computer storage media may include, but are not limited to: phase change memory (PRAM), static random access memory (SRAM), dynamic random access memory (DRAM), other types of random access memory (RAM), read only memory (ROM), electrically erasable programmable memory Read memory (EEPROM), flash memory or other memory technology, compact disc read only memory (CD-ROM), digital versatile disc (DVD) or other optical storage, magnetic tape cassettes, magnetic tape storage or other magnetic storage device or any other non-transmission medium, which may be used to store information that may be accessed by a computing device.

It should be noted that in the present disclosure, relational terms such as first and second are used only to distinguish one entity or operation from another entity or operation, and do not necessarily require or imply any such actual relationship or sequence between these entities or operations. The terms “include,” “comprise” or any other variations thereof are intended to cover the non-exclusive inclusion thereof. Thus a process, method, article or apparatus that includes a list of elements may include not only those listed elements, but also other elements not explicitly listed, or it may also include elements inherent to the process, method, article or apparatus. Without further restrictions, an element defined by the statement “comprises a . . . ” does not exclude the presence of additional identical elements in a process, method, article, or apparatus that includes the stated element.

The methods and devices provided by some exemplary embodiments of the present disclosure have been described in detail above. Certain specific examples are used to illustrate the principles and implementation methods of the present disclosure. The descriptions are only used to help understand the methods and devices, and core ideas of the present disclosure. Moreover, for a person of ordinary skill in the art, there may be changes in the specific implementation and application scope based on the ideas of the present disclosure. Therefore, the contents of this description should not be construed as limitations to the present disclosure.

What is claimed is:

1. A model obtaining method, comprising:
controlling a movable object carrying a load to move along a first path, and control the load, while moving, to collect first information of a target object during a movement;
establishing, based on the first information, an initial model of the target object;
planning, based on the initial model and a preset condition, at least one second path;
controlling the movable object to move along the at least one second path, and controlling the load, while moving, to collect second information of the target object; and
determining, based on at least the second information, a target model of the target object.

2. The method according to claim 1, wherein the load includes a camera;
the load collecting the first information of the target object includes the load shooting a plurality of primary images of the target object; and
the load collecting the second information of the target object includes the load shooting a plurality of supplementary images of the target object.

3. The method according to claim 1, wherein the preset condition includes at least one preset distance, and the at least one preset distance is a distance between the movable object and the target object.

4. The method according to claim 3, wherein the at least one second path includes a plurality of position points, and distances from the plurality of location points to a surface of the target object are substantially equal.

5. The method according to claim 3, wherein the at least one preset distance is smaller than distances between position points on the first path and the target object.

6. The method according to claim 3, wherein the planning of the at least one second path based on the initial model and the preset condition includes:
planning a plurality of the second paths based on the initial model and a plurality of the preset distances.

7. The method according to claim 6, wherein the plurality of the preset distances satisfy an equal proportion relationship.

8. The method according to claim 1, wherein the initial model includes position information of surface points of the target object; and
the planning of the at least one second path based on the initial model and the preset condition includes:
planning the at least one second path based on the position information and the preset condition.

9. The method according to claim 8, wherein the planning of the at least one second path based on the position information and the preset condition includes:
planning the at least one second path based on the position information, a region of interest selected from the initial model, and the at least one preset distance, wherein
position points on the at least one second path are distributed within the region of interest.

10. The method according to claim 1, wherein the first path and the at least one second path meet at least one of the following two conditions:
the first path includes a plurality of position points, wherein the plurality of position points are distributed in different directions with respect to the target object, are in substantially a same distance from the target object, and are substantially located at a same altitude, and the first path is configured to guide the movable object to move around the target object on a horizontal plane; or
the at least one second path includes a plurality of vertical paths, wherein the plurality of vertical paths are distributed in different directions with respect to the target object, and each vertical path is configured to guide the load to move upward or downward in a vertical direction.

11. The method according to claim 1, wherein the determining, based on at least the second information, a target model of the target object includes:
optimizing the initial model of the target object based on the second information to obtain the target model of the target object.

12. The method according to claim 11, wherein the first information includes primary images; the second information includes supplementary images; and
the optimizing of the initial model of the target object based on the second information includes:
performing feature point matching on a plurality of the supplementary images, and optimizing the initial model of the target object based on a result of the feature point matching.

13. The method according to claim 12, wherein the performing of the feature point matching on the plurality of the supplementary images includes:
performing feature point matching among the plurality of the supplementary images based on the initial model.

14. A model obtaining method, comprising:
obtaining position information of a target object;
planning, based on the position information, a first path and a second path for collecting information of the target object;
controlling a movable object to move along the first path and the second path respectively, wherein the first path is different from the second path;
controlling a load on the movable object to collect information of the target object while the movable object is moving, wherein first information collected by the load on the first path and second information collected by the load on the second path share information of at least one same point of the target object; and
establishing, based on the first information and the second information, a target model of the target object.

15. The method according to claim 14, wherein the load includes a camera;
the load collecting the information of the target object includes: the camera shooting a plurality of images of the target object; and
that the first information collected by the load on the first path and second information collected by the load on the second path share information of the at least one point of the target object includes: a first image captured by the camera on the movable object along the first path and a second image captured by the camera on the movable object along the second path share homologous image points of the target object.

16. The method according to claim 14, wherein the movable object maintains a first distance from the target object while moving along the first path, the movable object maintains a second distance from the target object while moving along the second path, and the first distance is greater than the second distance.

17. The method according to claim 14, wherein the first path and the second path meet at least one of the following two conditions:
the first path includes a plurality of position points, wherein the plurality of position points are distributed in different directions with respect to the target object, are in substantially a same distance from the target object, and are substantially located at a same altitude, and the first path is configured to guide the movable object to move around the target object on a horizontal plane; or
the second path includes a plurality of vertical paths, wherein the plurality of vertical paths are distributed in different directions with respect to the target object, and each vertical path is configured to guide the load to move upward or downward in a vertical direction.

18. The method according to claim 14, wherein position information of surface points of the target object is determined based on an initial model of the target object, and the initial model is determined in advance based on information collected along the first path.

19. The method according to claim 14, further comprising:
planning a third path based a region of interest on a surface of the target object; and
controlling the movable object to move along the third path to allow the load, while moving, to collect third information of the target object.

20. The method according to claim 14, wherein the target model includes a three-dimensional model.
